(19) United States
(12) Patent Application Publication
(10) Pub. No.: US 2026/0111214 A1
(43) Pub. Date: Apr. 23, 2026

(54) FIRMWARE UPDATE FOR A NETWORK INTERFACE DEVICE

(71) Applicant: Intel Corporation, Santa Clara, CA (US)

(72) Inventors: Agnieszka KOWALEWSKA, Banino (PL); Marina POPILOV, Herzlia (IL); Ilil BLUM SHEM-TOV, Kiryat Tivon (IL); Patrick G. KUTCH, Tigard, OR (US); Daniel LEIDERMAN, Kfar Saba (IL)

(21) Appl. No.: 19/423,469

(22) Filed: Dec. 17, 2025

(51) Int. Cl. G06F 8/65

(52) U.S. Cl. CPC G06F 8/65

(57) ABSTRACT

Examples described herein relate to a network interface device that includes: a host interface; direct memory access (DMA) engine; packet processing circuitry; and circuitry to, in response to a firmware update: based on retention of a local area network (LAN) configuration with a link partner in the firmware update: maintain a link with the link partner and continue utilization of the LAN configuration during execution of the firmware update and based on changes in LAN configuration with the link partner in the firmware update: permit reset of communication with the link partner and utilization of the LAN configuration in the firmware update.

### BACKGROUND

A network interface device (NID) is a hardware component that connects a device or computer to a network, enabling communication with other devices or systems. Firmware modifications can configure the network interface device with protocol updates, feature additions, and bug fixes through firmware modifications. However, firmware update causes service downtime as it can reduce or stop traffic from a network and host system. Such downtime is composed of the network device and controller downtime as well as interruption to traffic to the traffic partners.

### BRIEF DESCRIPTION OF THE DRAWINGS

FIG. 1 depicts an example system.

FIG. 2 depicts an example operation of a network interface device during a firmware update.

FIG. 3 depicts an example of operations.

FIG. 4 depicts an example process.

FIGS. 5A and 5B depict example network interface devices.

FIG. 6 depicts an example network interface device.

FIG. 7 depicts an example system.

### DETAILED DESCRIPTION

During a firmware update, it is desirable to reduce an amount of time a network interface device is inoperative. Inoperability of a network interface device can lead to loss of link with an Ethernet link partner, and exclusion of the network interface device from an active network device topology. Various examples can independently perform firmware updates to circuitry of a network interface device (e.g., packet processing pipeline, device interface, local area network (LAN) interface connection, controller (e.g., core), or others), to reduce interruption of operation of circuitry that is not subject to a firmware update or change in configuration. In some examples, a firmware can store discovered parameters of a currently established link, obtained during link up. Parameters, stored by former firmware, can be stored in persistent memory for access by the updated firmware.

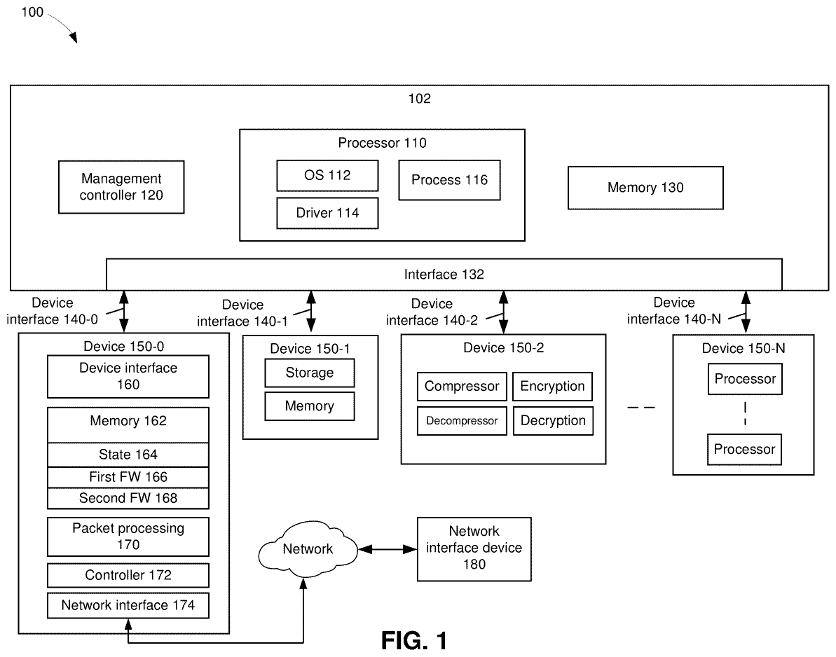

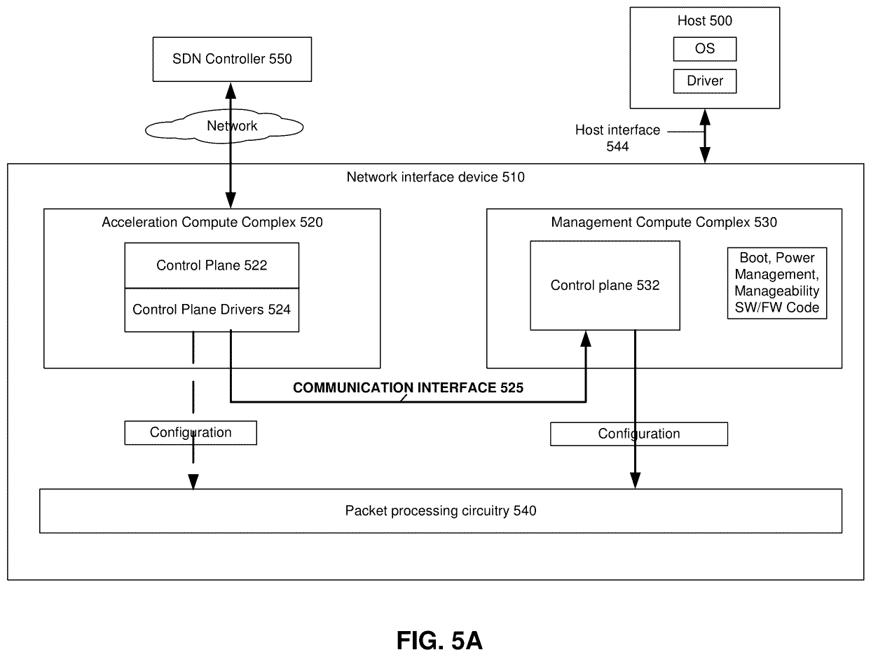

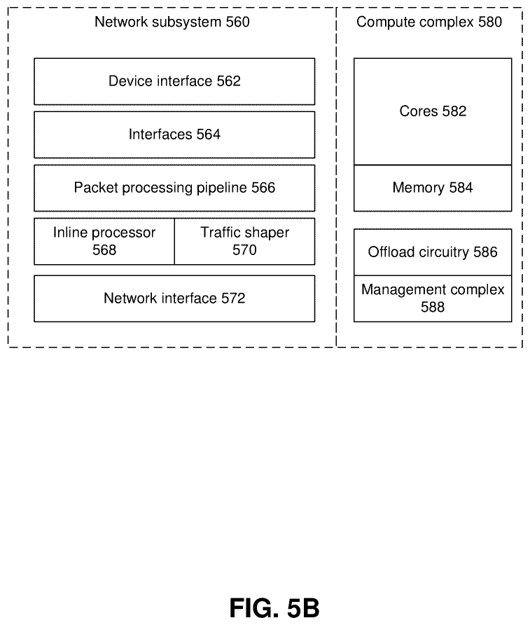

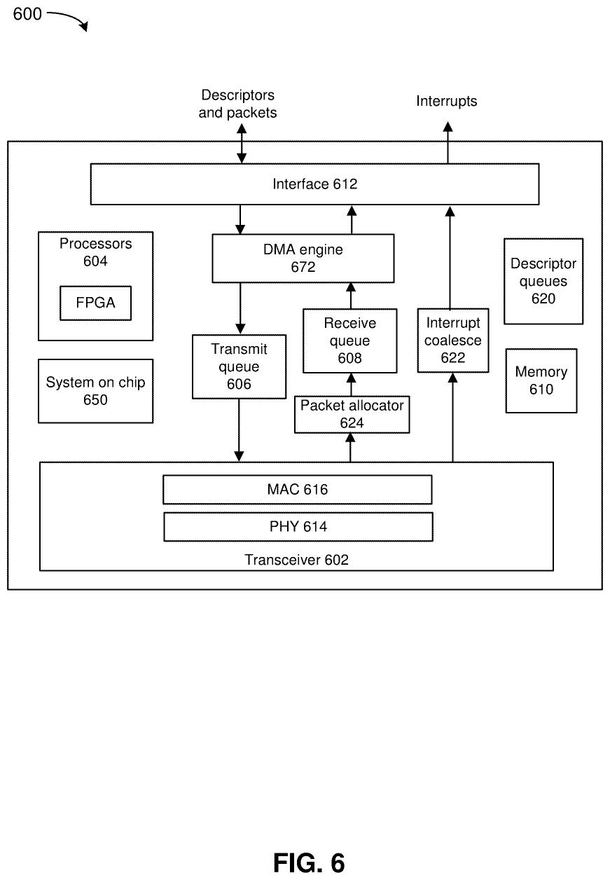

FIG. 1 depicts an example system. System 100 can include host system 102 coupled to one or more of devices 150-0 to 150-N, where N is an integer, and other circuitry and software described at least with respect to FIGS. 5A, 5B, 6, and/or 7. In some examples, system 100 can be implemented in a semiconductor package. The semiconductor package can include metal, plastic, glass, and/or ceramic casing that covers and encapsulates one or more semiconductor devices or integrated circuits (e.g., host system 102, or one or more of devices 150-0 to 150-N) and provides communications within or among the one or more semiconductor devices or integrated circuits.

Processor 110 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, processor-executed operating system (OS) 112 or driver 114 can advertise capability of one or more of devices 150-0 to 150-N to perform offloaded operations. One or more of devices 150-0 to 150-N can perform operations offloaded from processor 110. Processor 110 can execute processes 116 that can request packet processing, packet transmission, data compression, data decompression, data encryption, data decryption, data copying, or other operations to be performed by one or more of devices 150-0 to 150-N. Processes 116 can include one or more of: an application, process, thread, a virtual machine (VM), microVM, container, microservice, virtual function (VF), virtual device, or other virtualized execution environment.

Devices 150-0 to 150-N can include one or more of: an accelerator, a memory device, a memory controller, a storage device, a storage controller, a network interface device, or other circuitry, such as circuitry described with respect to FIGS. 5A, 5B, 6 and/or 7. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

Processor 110 can access one or more of devices 150-0 to 150-N using interface 132 and device interfaces 140-0 to 140-N consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

Management controller (MC) 120 can include circuitry configured to perform monitoring of device temperature, fan speeds, and power status. Management controller 120 can be configured to respond to remote actions by performance of actions such as power cycling, booting, and resetting devices or circuitry in host system 102 or one or more of devices 150-0 to 150-N. Management controller 120 can provide management capabilities independent of OS 112, through a dedicated management network port and can support protocols such as Intelligent Platform Management Interface (IPMI) and Redfish. Management controller 120 can provide telemetry and crash data for troubleshooting and proactive maintenance. Management controller 120 can be used to automate the initial setup and firmware updates for host system 102 or one or more of devices 150-0 to 150-N. In some examples, management controller 120 can be implemented as one or more of: Baseboard Management Controller (BMC), Intel® Management or Manageability Engine (ME), or other devices.

In some examples, device 150-0 can include a network interface device that can include device interface 160, memory 162, packet processing circuitry 170, controller 172, and network interface 174. Device interface 160 can communicatively couple device 150-0 via device interface 140-0 to interface 132 of host system 102.

Packet processing circuitry 170 can be implemented using one or more of: application specific integrated circuit (ASIC), field programmable gate array (FPGA), processors executing software, or other circuitry. Various examples of packet processing pipeline circuitry 140 are described herein. Controller 172 can configure packet processing pipeline circuitry 170 to perform operations related at least to issuances of non-volatile memory express (NVMe) reads or writes, issuances of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), local area network (LAN) packet transmissions or receipts, compression/decompression, encryption/decryption, configuration as a storage node, configuration as a tenant hosting node, configuration as a compute node, provide multiple different types of services between different Peripheral Component Interconnect Express (PCIe) end points, or other accelerated operations.

A packet may be used herein to refer to various formatted collections of bits that may be sent across a network, such as Ethernet frames, Internet Protocol (IP) packets, Transmission Control Protocol (TCP) segments, User Datagram Protocol (UDP) datagrams, etc.

Controller 172 can include one or more processor cores. Controller 172 can be configured to provide network policy rules into rule tables to configure operation of packet processing circuitry 170. For example, controller 172 can configure rule tables applied by packet processing pipeline circuitry 170 with rules to define a traffic destination based on packet type, flow identifier, and/or packet content. Controller 172 can program table rules (e.g., match-action) into memory accessible to packet processing pipeline circuitry 170.

Network interface 174 can include circuitry to receive and transmit packets over a transmission media. Various examples of network interface 174 include at least network interface 572 (FIG. 5B) or transceiver 602 (FIG. 6).

Memory 162 can include volatile and/or non-volatile memory including registers and cache. Memory 162 can store at least: states 164, first firmware (FW) 166, or second firmware 168. For example, states 164 can include states and operating configurations of device interface 160, packet processing circuitry 170, controller 172, and/or network interface 174. First firmware 166 and second firmware 168 can include microcode or instructions that configure network connectivity, security settings, and data processing operations of device interface 160, packet processing circuitry 170, controller 172, and network interface 174.

For example, while device 150-0 executes first firmware 166, host driver 114 or management controller 120 can provide second firmware 146 into memory 162. Based on storage of second firmware 168 into memory 162, device controller 172 can compare changes of configurations from first firmware 166 to second firmware 168 for one or more of: device interface 160, packet processing 170, controller 172, or network interface 174. In some examples, controller 172 can include multiple cores and a first core of the cores can continue to perform control plane operations while a second core of the cores determines changes in configuration from first firmware 166 to second firmware 168 for one or more of: device interface 160, packet processing 170, controller 172, or network interface 174.

For example, for configuration of network interface 174, device controller 172 can compare first firmware 166 and second firmware 168 changes in at least: physical layer interface (PHY) configuration, media access controller (MAC) autoload registers, instructions in firmware, or scripts and configuration associated with Ethernet traffic settings. If controller 172 detects no changes for LAN configuration between first firmware 166 and second firmware 168 for network interface 174, network interface 174 can maintain a link with the link partner (e.g., network interface device 180). Maintaining a link with the link partner can include receiving or transmitting packets within an idle timeout configured by OS 112. Controller 172 can avoid link reset with a link partner (e.g., network interface device 180) by maintaining operation at least of network interface 174 (e.g., PHY, MAC, or others) during transition from execution of first firmware 166 to execution of second firmware 168. For example, controller 172 can retain LAN port configurations and state 164 of network interface 174, switch to execution of second firmware 168, boot second firmware 168, and apply retained LAN port configurations and state. State 164 can include at least maximum link speed, active number of ports, temperature of module inserted into a port, current power consumption of module inserted into a port, permitted forward error correction (FEC) settings, connectable modules (e.g., permit/deny optical cables, permit/deny electrical cables), or others.

However, if controller 172 detects changes for LAN configuration for network interface 174 between first firmware 166 and second firmware 168, then network interface 174 can perform a reset to apply updated configuration and may not retain utilization of state 164 after utilization of second firmware 168. A connection with a link partner can be disrupted and device 150-0 may be dropped from an active network device topology.

For example, for configuration of device interface 160, device controller 172 can compare changes between first firmware 166 and second firmware 168 in at least: configurations associated with PCIe re-enumeration configurations, PCIe autoload registers, firmware code, physical function changes, values in Base Address Registers (BAR), PCIe configuration space, or others. PCIe configuration space can include at least a memory region for device 150-0 (e.g., Vendor/Device identifiers (IDs), status, and capabilities), allowing OS 112 and driver 114 to discover, initialize, and manage device 150-0 during boot and runtime.

If controller 172 detects no changes for device interface configuration between first firmware 166 and second firmware 168 for device interface 160, device interface 160 can maintain a connection with a root port of interface 132 of host system 102 and avoid PCIe reset. However, if controller 172 detects changes for device interface configuration between first firmware 166 and second firmware 168 for device interface 160, device interface 160 can apply the updates. A connection with a root port of a root complex of interface 132 can be disrupted.

For example, for configuration of packet processing circuitry 170, device controller 172 can compare first firmware 166 and second firmware 168 changes in at least: link configuration changes, number of available LAN ports, mapping of LAN ports to PCIe Physical Functions (PFs), and ports internal structure (e.g., breakout or non-breakout (e.g., single lane)), port configuration (e.g., number of active ports, maximum port speed, power limit on inserted modules, permitted forward error correction (FEC) settings, allowed modules (e.g., permit/deny optical cables, permit/deny electrical cables)), or others. If controller 172 detects no changes for configuration of packet processing circuitry 170 between first firmware 166 and second firmware 168 for packet processing 170, packet processing circuitry 170 can maintain operations of packet processing based on a configuration from first firmware 166 and apply former context/state (e.g., information about currently established link parameters (e.g., speed, signal detected, auto negotiation completion, Energy Efficient Ethernet (EEE) being active, transmit and receive pause of both device itself and link partner, or others). Context/state can be stored for access by second firmware 168. After start of second firmware 168, second firmware 168 can check if link related hardware is still in a same state as before start of second firmware 168 (e.g., cable did not get disconnected and link partner is still active).

If controller 172 detects changes for configuration of packet processing circuitry 170 between first firmware 166 and second firmware 168 for packet processing circuitry 170, packet processing circuitry 170 can be reset, and a disruption of packet processing can occur as processing pipeline queues may be flushed and lookup tables erased to utilize lookup tables in second firmware 168.

To permit maintaining a connection between link partners (e.g., transport layer tcp_keep_alive) during a reset to execute second firmware 168, device 150-0 or a Transmission Control Protocol (TCP) stack of OS 112 can be configured to maintain a link with a link partner (e.g., network interface device 180) despite a reduction in a rate of packet processing, packet receipt, or packet transmission during a reset of device interface 160, packet processing circuitry 170, or network interface 174 to execute second firmware 168. For example, TCP/IP stack of OS 112 can be configured to extend a connection life, despite reduced operation of circuitry of a network interface device (e.g., device 150-0) during switching to utilization of second firmware 168 by increasing initial idle timeout, a time period to close a TCP connection that has no traffic flowing through it. Initial idle timeout can be increased by increasing the initial idle time before sending probes (tcp_keepalive_time) and increasing an interval between probes if the link partner does not respond (tcp_keepalive_intvl), while decreasing the number of unanswered probes before terminating the connection (tcp_keepalive_probes).

In some examples, increasing acknowledgement (ACK) windows can slow down a transmission rate of packets to reduce a likelihood of link loss during change to utilization of second firmware 168. In some examples, increasing a retransmission timeout time duration, that a sender uses to wait for an acknowledgement (ACK) for a sent packet, can reduce a likelihood of link loss during a change to utilization of second firmware 168.

To permit maintaining a connection between link partners during a reset to execute second firmware 168, device 150-0 or OS 112 can be configured to maintain a link with a link partner (e.g., network interface device 180) by transmitting keepalive packets during the firmware update as well as re-transmitting keepalive packets if an acknowledgement of receipt is not received. A keepalive packet can include a particular code that identifies an Ethernet frame as a heartbeat communication. In some examples, timeout intervals can be increased so that inactivity of a network interface device during a firmware update is less likely to cause a loss of link with a link partner.

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, memory 130, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

In some examples, system 100 can be implemented as part of a system-on-a-chip (SoC) or system in package (SiP). Various examples of system 100 can be implemented as a discrete device, in a die, in a chip, on a die or chip mounted to a circuit board, in a package, or between multiple packages, in a server, in a CPU socket, or among multiple servers.

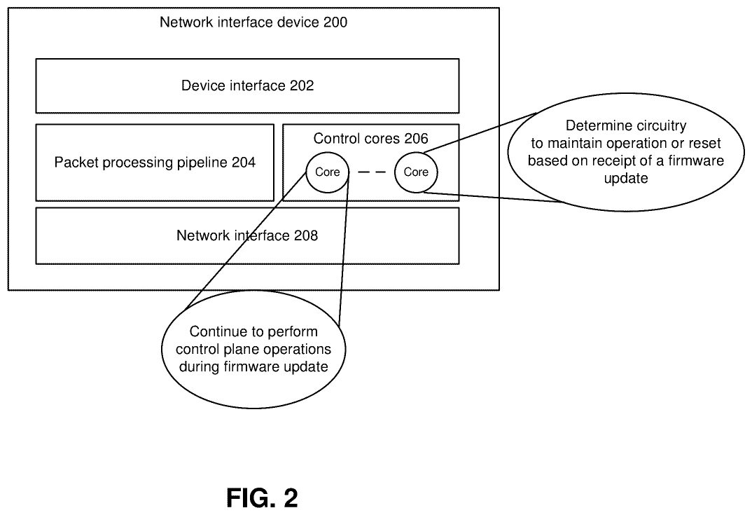

FIG. 2 depicts an example operation of a network interface device during a firmware update. Based on an update in firmware or change in configurations, a first core of control cores 206 can determine whether operation of device interface 202, packet processing pipeline 204, or network interface 208 can be maintained. A second core of control cores 206 can continue control plane operations during a firmware or control plane code update by utilizing a state of a control core.

For example, based on an update to a configuration of device interface 202, processing pipeline 204 and network interface 208 may not receive downtime indications from control cores 206 so that operations of processing pipeline 204 and network interface 208 can continue despite disruption in operation of device interface 202.

For example, based on an update to a configuration of network interface 208, device interface 202 and processing pipeline 204 may not receive downtime indications from control cores 206 so that operations of device interface 202 and processing pipeline 204 can continue despite disruption in operation of network interface 208.

For example, based on an update to a configuration (e.g., rule tables) to packet processing pipeline 204, device interface 202 and network interface 208 may not receive downtime indications from packet processing pipeline 204 or control cores 206 so that operations of device interface 202 and network interface 208 can continue despite disruption in operation of packet processing pipeline 204.

Various examples can apply to other devices such as accelerators, graphics processing units, or other devices.

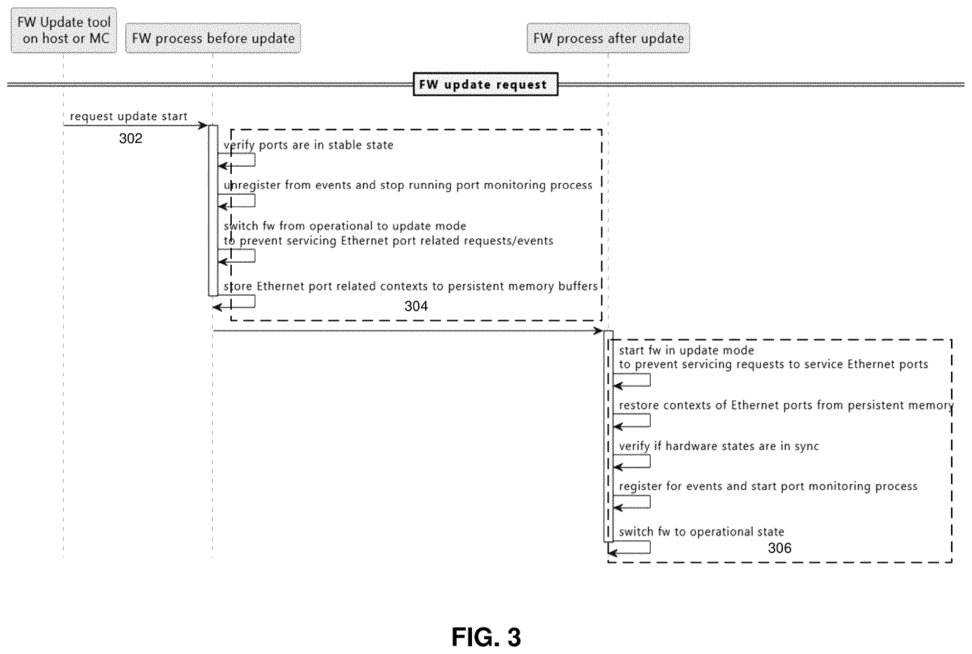

FIG. 3 depicts an example of operations. At 302, a firmware (FW) update tool on a host system or management controller can issue a firmware update to a network interface device. Operation request update start can indicate to the executing firmware that a firmware update binary is to be sent to the network interface device.

At 304, the network interface device can prepare for changing firmware to the firmware update. For example, the control core can verify ports are in a stable operational state, unregister from events, stop running port monitoring process (e.g. verifying link partner presence, PHY module power consumption, etc.) and store Ethernet port related context into persistent memory, for restoration purposes, after the firmware update.

At 306, the firmware update can be executed without resetting circuitry of the network interface device. For example, based on unchanged configurations for network interface (e.g., PHY and MAC), a device interface (e.g., PCIe interface), packet processing circuitry, and microcontroller (e.g., control core), such circuitry may continue operation and not reset.

An operation of starting firmware in update mode can cause execution of the firmware update. An operation of restore contexts of Ethernet ports from persistent memory can cause firmware in update mode to retrieve existing context of Ethernet ports (e.g., temperature of module inserted into a port, current power consumption of module inserted into a port, or others). An operation of verify if hardware states are in sync can determine if an updated firmware image is staged and there are no detected changes to configurations of network interface, processing pipeline, control cores, or device interface. An operation of register for events and start port monitoring process can trigger updated firmware to enter regular operating mode. An operation of switch firmware to operational state can cause updated firmware to enter regular operating mode.

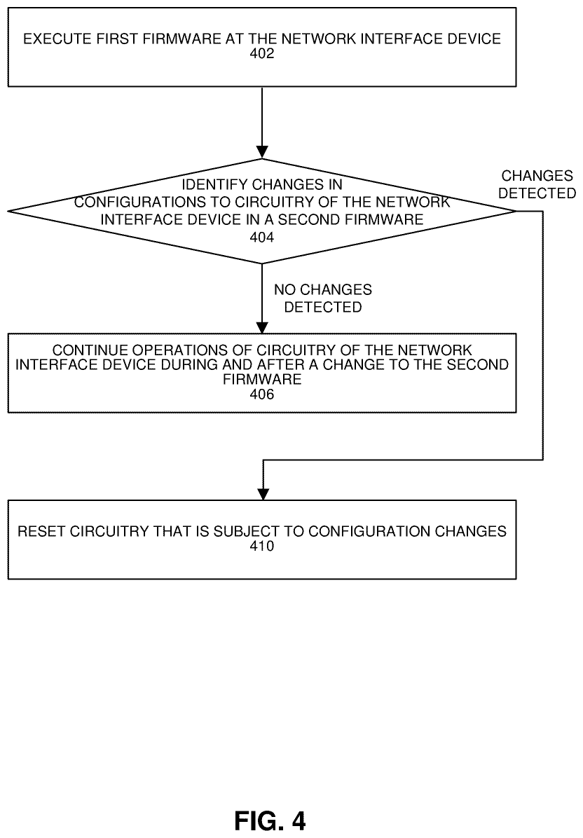

FIG. 4 depicts an example process. The process can be performed by a network interface device in connection with a firmware update. At 402, the network interface device can apply configurations in a first firmware while performing packet processing of received and transmitted packets, interfacing with a link partner through a network interface, and interfacing with a host system via a host or device interface. At 404, based on receipt of a second firmware, the network interface device can determine if the second firmware changes configurations of circuitry of the network interface device from those of the first firmware. Circuitry can include at least network interface, host interface, or packet processing circuitry. In some examples, a processor in the network interface device or host system can determine if the second firmware changes configurations of circuitry of the network interface device from those of the first firmware.

At 406, based on no change in a configuration of circuitry of the network interface device, operation of the circuitry can continue while utilizing the second firmware. For example, configurations of network interface, host interface, and packet processing circuitry may be unchanged from the first firmware to the second firmware and operations of the network interface, host interface, and packet processing circuitry may continue during change from utilization of the first firmware to utilization of the second firmware.

At 410, based on a change in a configuration of specific circuitry of the network interface device, a reset in operation of the specific circuitry can occur. For example, based on a change in configuration of the network interface, the network interface may reset and a link reset or timeout may occur. For example, based on a change in configuration of the host interface, the host interface may reset and a connection with a root port may be lost and a re-enumeration of the network interface device may take place. For example, based on a change in configuration of the packet processing circuitry, the packet processing circuitry may reset and packet processing operations can be disrupted.

FIG. 5A depicts an example system. Host 500 can include processors, memory devices, device interfaces, as well as other circuitry such as described with respect to one or more of FIGS. 5B, 6, and/or 7. Processors of host 500 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes. Host 500 can be coupled to network interface device 510 via a host or device interface 544.

Various examples of network interface device 510 can be configured to selectively reset circuitry during a firmware update. Network interface device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), or application specific integrated circuit (ASIC). Similarly, MCC 530 can be implemented as one or more of: a microprocessor, processor, accelerator, field programmable gate array (FPGA), or application specific integrated circuit (ASIC). In some examples, ACC 520 and MCC 530 can be implemented as separate cores in a CPU, different cores in different CPUs, different processors in a same integrated circuit, different processors in different integrated circuit. In some examples, circuitry and software of network interface device 510 can be configured to determine whether to divert a packet to a buffer in supplemental memory or drop packets and when to egress packets, as described herein.

Network interface device 510 can be implemented as one or more of: a microprocessor, processor, accelerator, field programmable gate array (FPGA), or application specific integrated circuit (ASIC). Packet processing pipeline circuitry 540 can process packets as directed or configured by one or more control planes executed by multiple compute complexes. For example, processing pipeline circuitry 540 can be configured to determine whether to store packets in a buffer in memory of network interface 750 or another device or drop packets and when to egress packets, as described herein. In some examples, ACC 520 and MCC 530 can execute respective control planes 522 and 532.

SDN controller 550 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 550 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 550 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 550 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to a management controller (e.g., Baseboard Management Controller (BMC)), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device system. Various examples of packet processing device or network interface device 510 can utilize components of the system of FIG. 5A or 6. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 560 can be communicatively coupled to compute complex 580. Device interface 562 can provide an interface to communicate with a host. Various examples of device interface 562 can utilize protocols based on Peripheral Component Interconnect Express (PCIe), Compute Express Link (CXL), or others as well as virtual device interface such as virtual device interfaces.

Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification version 1 (2019), as well as earlier versions, later versions, and variations thereof.

Interfaces 564 can initiate and terminate at least offloaded remote direct memory access (RDMA) operations, Non-volatile memory express (NVMe) reads or writes operations, and LAN operations. Packet processing pipeline 566 can perform packet processing (e.g., packet header and/or packet payload) based on a configuration and support quality of service (QoS) and telemetry reporting. Inline processor 568 can perform offloaded encryption or decryption of packet communications (e.g., Internet Protocol Security (IPSec) or others). Traffic shaper 570 can schedule transmission of communications. Network interface 572 can provide an interface at least to an Ethernet network by media access control (MAC) and serializer/de-serializer (Serdes) operations.

Cores 582 can be configured to perform infrastructure operations such as storage initiator, Transport Layer Security (TLS) proxy, virtual switch (e.g., vSwitch), or other operations. Memory 584 can store applications and data to be performed or processed. Offload circuitry 586 can perform at least cryptographic and compression operations for host or use by compute complex 580. Offload circuitry 586 can include one or more graphics processing units (GPUs) that can access memory 584. Management complex 588 can perform secure boot, life cycle management and management of network subsystem 560 and/or compute complex 580.

FIG. 6 depicts an example network interface device or packet processing device. In some examples, packet processing device 600 can be implemented as a network interface controller, network interface card, a host fabric interface (HFI), or host bus adapter (HBA), and such examples can be interchangeable. Various examples of packet processing device 600 can be configured to selectively reset circuitry during a firmware update, as described herein.

Packet processing device 600 can be coupled to one or more servers using a bus, PCIe, CXL, or Double Data Rate (DDR). Packet processing device 600 may be embodied as part of a system-on-a-chip (SoC) that includes one or more processors, or included on a multichip package that also contains one or more processors.

Some examples of packet processing device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and host interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

As described herein, host interface 612 can be configured as a PCIe switch or host interface to provide communications among a host (not shown) as well as circuitry of network interface 600. Routing of communications among host (not shown) as well as circuitry of network interface 600, as described herein.

System on chip (SoC) 650 and processors 604 can include any a combination of: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604.

Processors 604 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 604, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Host interface 612 can provide an interface with host device (not depicted). For example, host interface 612 can be compatible with PCI, PCI Express, PCI-x, Serial ATA, and/or USB compatible interface (although other interconnection standards may be used).

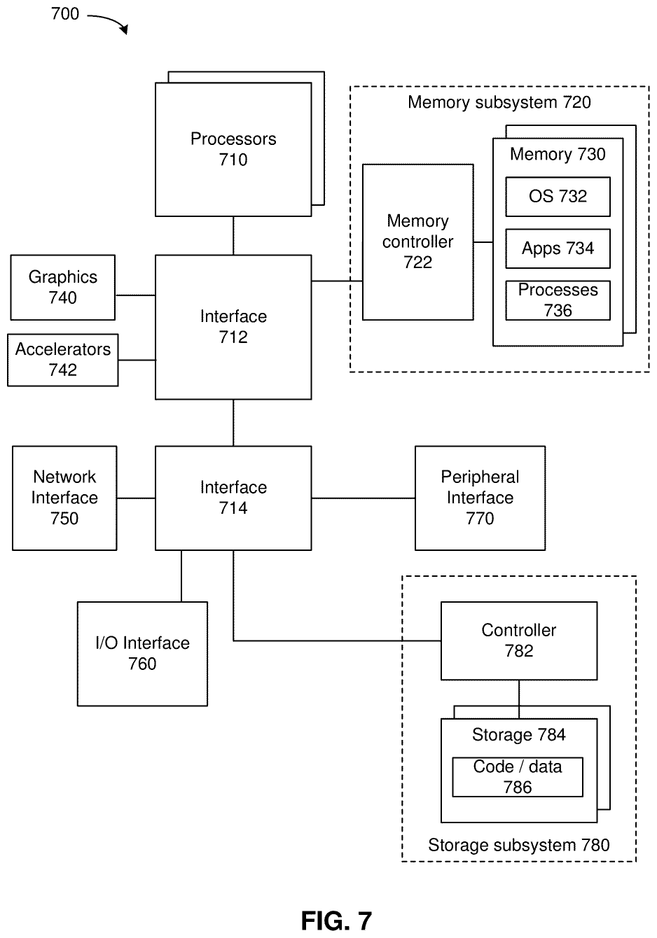

FIG. 7 depicts a system. In some examples, network interface device 750 can determine whether to maintain operation of circuitry of network interface device 750 in response to a change in firmware, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card. ” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and includes an apparatus comprising: a network interface device comprising: a host interface; direct memory access (DMA) engine; packet processing circuitry; and circuitry to, in response to a firmware update: based on retention of a local area network (LAN) configuration with a link partner in the firmware update: maintain a link with the link partner and continue utilization of the LAN configuration during execution of the firmware update and based on changes in the LAN configuration with the link partner in the firmware update: permit reset of communication with the link partner and utilization of a second LAN configuration in the firmware update.

Example 2 includes one or more examples, wherein the LAN configuration comprises one or more of: LAN physical layer interface (PHY) media access controller (MAC) autoload registers, instructions in the firmware, or configuration associated with Ethernet traffic setting.

Example 3 includes one or more examples, wherein the LAN configuration comprises one or more of: maximum link speed, active number of ports, temperature of module inserted into a port, current power consumption of module inserted into a port, permitted forward error correction (FEC) settings, or connectable modules.

Example 3 includes one or more examples, wherein the LAN configuration comprises one or more of: maximum link speed, active number of ports, temperature of module inserted into a port, current power consumption of module inserted into a port, permitted forward error correction (FEC) settings, or connectable modules.

Example 4 includes one or more examples, wherein the utilization of the LAN configuration in the firmware update comprises maintain link with a partner network interface device and apply LAN port states from a prior firmware.

Example 5 includes one or more examples, wherein the circuitry is to, in response to a firmware update: based on retention of a packet processing circuitry configuration in the firmware update: maintain operations of the packet processing circuitry for the firmware update and based on changes in the packet processing circuitry configuration in the firmware update: permit reset of the packet processing circuitry, flush processing pipeline queues, and erase lookup tables of the packet processing circuitry.

Example 6 includes one or more examples, wherein the circuitry is to, in response to a firmware update: based on retention of a host interface configuration in the firmware update: maintain communications over the host interface with a host system and based on changes in the host interface configuration in the firmware update: permit disruption in communications over the host interface with the host system.

Example 7 includes one or more examples, wherein the host interface configuration comprises one or more of: host interface autoload registers, firmware code, and configuration associated with re-enumeration of the host interface.

Example 8 includes one or more examples, and includes at least one non-transitory computer-readable medium comprising instructions stored thereon, that if executed by one or more processors of a network interface device, cause the one or more processors to: in response to a firmware update of a network interface device: based on retention a local area network (LAN) configuration with a link partner in the firmware update: maintain a link with the link partner and utilization of the LAN configuration in the firmware update and based on changes in LAN configuration with the link partner in the firmware update: permit reset of communication with the link partner and utilization of a second LAN configuration in the firmware update.

Example 9 includes one or more examples, wherein the LAN configuration comprises one or more of: LAN physical layer interface (PHY) media access controller (MAC) autoload registers, instructions in the firmware, or configuration associated with Ethernet traffic setting.

Example 10 includes one or more examples, wherein the LAN configuration comprises one or more of: maximum link speed, active number of ports, temperature of module inserted into a port, current power consumption of module inserted into a port, permitted forward error correction (FEC) settings, or connectable modules.

Example 11 includes one or more examples, wherein the utilization of the LAN configuration in the firmware update comprises maintain link with a partner network interface device and apply LAN port states from a prior firmware.

Example 12 includes one or more examples, and includes instructions stored thereon, that if executed by one or more processors of a network interface device, cause the one or more processors to: in response to a firmware update of a network interface device: based on retention of a packet processing circuitry configuration in the firmware update: maintain operations of the packet processing circuitry for the firmware update and based on changes in the packet processing circuitry configuration in the firmware update: permit reset of the packet processing circuitry, flush processing pipeline queues, and erase lookup tables of the packet processing circuitry.

Example 13 includes one or more examples, and includes instructions stored thereon, that if executed by one or more processors of a network interface device, cause the one or more processors to: based on retention of a host interface configuration in the firmware update: maintain communications over the host interface with a host system and based on changes in the host interface configuration in the firmware update: permit disruption in communications over the host interface with the host system.

Example 14 includes one or more examples, wherein the host interface configuration comprises one or more of: host interface autoload registers, firmware code, and configuration associated with host interface re-enumeration.

Example 15 includes one or more examples, and includes a method comprising: in response to a firmware update of a network interface device: based on retention a local area network (LAN) configuration with a link partner in the firmware update: maintaining a link with the link partner and utilization of the LAN configuration in the firmware update and based on changes in LAN configuration with the link partner in the firmware update: permitting reset of communication with the link partner and utilization of a second LAN configuration in the firmware update.

Example 16 includes one or more examples, wherein the LAN configuration comprises one or more of: LAN physical layer interface (PHY) media access controller (MAC) autoload registers, instructions in the firmware, or configuration associated with Ethernet traffic setting.

Example 17 includes one or more examples, wherein the LAN configuration comprises one or more of: maximum link speed, active number of ports, temperature of module inserted into port, current power consumption of module inserted into port, permitted forward error correction (FEC) settings, or connectable modules.

Example 18 includes one or more examples, wherein the utilization of the LAN configuration in the firmware update comprises maintain link with partner network interface device and apply LAN port states from a prior firmware.

Example 19 includes one or more examples, and includes in response to a firmware update of the network interface device: based on retention of a packet processing circuitry configuration in the firmware update: maintaining operations of the packet processing circuitry for the firmware update and based on changes in the packet processing circuitry configuration in the firmware update: permitting reset of the packet processing circuitry, flush processing pipeline queues, and erase lookup tables of the packet processing circuitry.

Example 20 includes one or more examples, and includes in response to a firmware update: based on retention of a host interface configuration in the firmware update: maintaining communications over the host interface with a host system and based on changes in the host interface configuration in the firmware update: permitting disruption in communications over the host interface with the host system.

1. An apparatus comprising:
a network interface device comprising:
a host interface;
direct memory access (DMA) engine;
packet processing circuitry; and
circuitry to, in response to a firmware update:
based on retention of a local area network (LAN) configuration with a link partner in the firmware update: maintain a link with the link partner and continue utilization of the LAN configuration during execution of the firmware update and
based on changes in the LAN configuration with the link partner in the firmware update: permit reset of communication with the link partner and utilization of a second LAN configuration in the firmware update.

2. The apparatus of claim 1, wherein the LAN configuration comprises one or more of: LAN physical layer interface (PHY) media access controller (MAC) autoload registers, instructions in the firmware, or configuration associated with Ethernet traffic setting.

3. The apparatus of claim 1, wherein the LAN configuration comprises one or more of: maximum link speed, active number of ports, temperature of module inserted into a port, current power consumption of module inserted into a port, permitted forward error correction (FEC) settings, or connectable modules.

4. The apparatus of claim 1, wherein the utilization of the LAN configuration in the firmware update comprises maintain link with a partner network interface device and apply LAN port states from a prior firmware.

5. The apparatus of claim 1, wherein the circuitry is to, in response to a firmware update:
based on retention of a packet processing circuitry configuration in the firmware update: maintain operations of the packet processing circuitry for the firmware update and based on changes in the packet processing circuitry configuration in the firmware update:
permit reset of the packet processing circuitry, flush processing pipeline queues, and erase lookup tables of the packet processing circuitry.

6. The apparatus of claim 1, wherein the circuitry is to, in response to a firmware update:
based on retention of a host interface configuration in the firmware update: maintain communications over the host interface with a host system and
based on changes in the host interface configuration in the firmware update: permit disruption in communications over the host interface with the host system.

7. The apparatus of claim 6, wherein the host interface configuration comprises one or more of: host interface autoload registers, firmware code, and configuration associated with re-enumeration of the host interface.

8. At least one non-transitory computer-readable medium comprising instructions stored thereon, that if executed by one or more processors of a network interface device, cause the one or more processors to:
in response to a firmware update of a network interface device:
based on retention a local area network (LAN) configuration with a link partner in the firmware update: maintain a link with the link partner and utilization of the LAN configuration in the firmware update and
based on changes in LAN configuration with the link partner in the firmware update: permit reset of communication with the link partner and utilization of a second LAN configuration in the firmware update.

9. The computer-readable medium of claim 8, wherein the LAN configuration comprises one or more of: LAN physical layer interface (PHY) media access controller (MAC) autoload registers, instructions in the firmware, or configuration associated with Ethernet traffic setting.

10. The computer-readable medium of claim 8, wherein the LAN configuration comprises one or more of: maximum link speed, active number of ports, temperature of module inserted into a port, current power consumption of module inserted into a port, permitted forward error correction (FEC) settings, or connectable modules.

11. The computer-readable medium of claim 8, wherein the utilization of the LAN configuration in the firmware update comprises maintain link with a partner network interface device and apply LAN port states from a prior firmware.

12. The computer-readable medium of claim 8, comprising instructions stored thereon, that if executed by one or more processors of a network interface device, cause the one or more processors to:
in response to a firmware update of a network interface device:
based on retention of a packet processing circuitry configuration in the firmware update:
maintain operations of the packet processing circuitry for the firmware update and based on changes in the packet processing circuitry configuration in the firmware update:
permit reset of the packet processing circuitry, flush processing pipeline queues, and erase lookup tables of the packet processing circuitry.

13. The computer-readable medium of claim 8, comprising instructions stored thereon, that if executed by one or more processors of a network interface device, cause the one or more processors to:
based on retention of a host interface configuration in the firmware update: maintain communications over the host interface with a host system and
based on changes in the host interface configuration in the firmware update: permit disruption in communications over the host interface with the host system.

14. The computer-readable medium of claim 13, wherein the host interface configuration comprises one or more of: host interface autoload registers, firmware code, and configuration associated with host interface re-enumeration.

15. A method comprising:
in response to a firmware update of a network interface device:
based on retention a local area network (LAN) configuration with a link partner in the firmware update: maintaining a link with the link partner and utilization of the LAN configuration in the firmware update and
based on changes in LAN configuration with the link partner in the firmware update: permitting reset of communication with the link partner and utilization of a second LAN configuration in the firmware update.

16. The method of claim 15, wherein the LAN configuration comprises one or more of: LAN physical layer interface (PHY) media access controller (MAC) autoload registers, instructions in the firmware, or configuration associated with Ethernet traffic setting.

17. The method of claim 15, wherein the LAN configuration comprises one or more of: maximum link speed, active number of ports, temperature of module inserted into port, current power consumption of module inserted into port, permitted forward error correction (FEC) settings, or connectable modules.

18. The method of claim 15, wherein the utilization of the LAN configuration in the firmware update comprises maintain link with partner network interface device and apply LAN port states from a prior firmware.

19. The method of claim 15, comprising:
in response to a firmware update of the network interface device:
based on retention of a packet processing circuitry configuration in the firmware update: maintaining operations of the packet processing circuitry for the firmware update and based on changes in the packet processing circuitry configuration in the firmware update:
permitting reset of the packet processing circuitry, flush processing pipeline queues, and erase lookup tables of the packet processing circuitry.

20. The method of claim 15, comprising:
in response to a firmware update:
based on retention of a host interface configuration in the firmware update: maintaining communications over the host interface with a host system and
based on changes in the host interface configuration in the firmware update: permitting disruption in communications over the host interface with the host system.
